(19) United States
(12) Patent Application Publication
(10) Pub. No.: US 2008/0100195 A1
(43) Pub. Date: May 1, 2008

(54) COMPOSITION FOR PREPARING EMITTER, METHOD OF PREPARING THE EMITTER USING THE COMPOSITION, EMITTER PREPARED USING THE METHOD AND ELECTRON EMISSION DEVICE INCLUDING THE EMITTER

(75) Inventors: Yoon-Jin KIM, Suwon-si (KR); Jae-Myung Kim, Suwon-si (KR); Hee-Sung Moon, Suwon-si (KR)

Correspondence Address: STEIN, MCEWEN & BUI, LLP, 1400 EYE STREET, NW, SUITE 300, WASHINGTON, DC, 20005, US

(73) Assignee: Samsung SDI Co., Ltd., Suwon-si (KR)

(21) Appl. No.: 11/865,226

(22) Filed: Oct. 1, 2007

(30) Foreign Application Priority Data
Nov. 1, 2006 (KR) 2006-107459

(51) Int. Cl. H01J 1/62; B05D 5/12; H01B 1/04

(52) U.S. Cl. 313/495; 252/516; 427/78

(57) ABSTRACT

A composition for preparing an emitter including: flake type carbide-derived carbon which is prepared by thermochemically reacting carbide compounds with halogen-containing gases to extract all elements of the carbide compounds except carbon, an organic solvent and a dispersant. A method of preparing the emitter using the composition for forming the emitter, an emitter prepared using the method and an electron emission device. The emitter has good uniformity and a long lifetime. It can be prepared using a more inexpensive method than using conventional carbon nanotubes. A pattern can be formed by easily regulating the size of the manufactured emitter using an ink jet printer. Non-uniform emission generated by residue when using a conventional printing method can be avoided. Thus, a micro electrode, in which an arc discharge does not occur even in the presence of a strong electric field, can be conveniently manufactured.

### CROSS-REFERENCE TO RELATED APPLICATIONS

This application claims the benefit of Korean Application No. 2006-107459, filed on Nov. 1, 2007, in the Korean Intellectual Property Office, the disclosure of which is incorporated herein by reference.

### BACKGROUND OF THE INVENTION

1. Field of the Invention

Aspects of the present invention relate to a composition for an emitter where the composition includes carbide-derived carbon, a method of preparing the emitter using the composition, an emitter prepared using the method and an electron emission device. More particularly, aspects of the present invention relate to a composition for an emitter in which the emitter can be prepared to have good uniformity and a long lifetime using a less expensive method than that using conventional carbon nanotubes and in which a pattern can be formed by easily regulating the size of the manufactured emitter, using an ink jet method, without using an additional patterning method; as well as the method of preparing the emitter using the composition, the emitter prepared using the method and the electron emission device including the emitter.

2. Description of the Related Art

In general, electron emission devices can be classified into electron emission devices using hot cathodes as an electron emission source and electron emission devices using cold cathodes as an electron emission source. Examples of electron emission devices using cold cathodes as an electron emission source include field emitter array (FEA) type electron emission devices, surface conduction emitter (SCE) type electron emission devices, metal insulator metal (MIM) type electron emission devices, metal insulator semiconductor (MIS) type electron emission devices, ballistic electron surface emitting (BSE) type electron emission devices, etc.

In the electron emission devices using cold cathodes as an electron emission source, carbon-based materials that are commonly used in an emitter, for example, carbon nanotubes, have good conductivity, good electric field concentration, good electric field emission properties and a low work function.

However, commonly used fiber type carbon nanotubes have a high field enhancement factor, β. Materials of fiber type carbon nanotubes have many problems such as bad uniformity, a short lifetime, and the like. Fiber type carbon nanotubes manufactured using paste, ink, slurry, or the like, have manufacturing problems compared with carbon nanotubes formed of particle type materials. In addition, fiber type materials are very expensive.

Recently, in order to overcome the problems described above, research has been conducted into materials for replacing carbon nanotubes using inexpensive carbide-based compounds. In particular, Korean Patent Publication No. 2001-13225 discloses a method of manufacturing a porous carbon product including: i) forming a workpiece having a transport porosity using carbide as a carbon precursor, ii) forming nanopores in the workpiece by thermochemically treating the workpiece, and iii) using the manufactured porous carbon product as electrode materials for electric layer capacitors. Meanwhile, Russian Patent Publication No. 2,249,876 discloses applying nano porous carbon to cold cathodes, in which the nano porosities having predetermined sizes are distributed.

With regard to a method of preparing an emitter, various methods are commonly used. For example, an emitter can be prepared using a method including preparing a paste composition for forming the emitter and printing, calcinating and activating the resulting product, as well as a method of growing carbon-based materials directly on a substrate. In particular, a commonly used method of forming an emitter includes preparing an ink composition by ejecting the ink onto a substrate using an ink jet method (Korean Patent Publication No. 2002-80393).

The method of forming the emitter using the ink jet method can reduce manufacturing processes in that additional exposing and developing operations are not required. Use of the ink jet method prevents a loss of material and prevents non-uniform electron emission due to residue (undeveloped emitter) at undesired positions. Accordingly, the ink jet method is more advantageous than other methods for forming an emitter.

However, since carbon nanotubes, graphite fibers, or the like, which are used in conventional ink compositions for forming emitters, have a high aspect ratio and high field enhancement factor, β, these forms are not suitable for preparing an emitter by the ink jet method.

### SUMMARY OF THE INVENTION

Aspects of the present invention provide a composition for an emitter by which the emitter can be prepared using a less expensive method than that using conventional carbon nanotubes in which a pattern can be formed by easily regulating the size of the manufactured emitter, using an ink jet method, without using an additional patterning method. Additional aspects of the present invention include a method of preparing the emitter using the composition for forming the emitter, an emitter prepared using the method and an electron emission device including the emitter.

More particularly, an aspect of the present invention provides a composition for an emitter including: carbide-derived carbon which is prepared by thermochemically-reacting carbide compounds with halogen-containing gases to extract all elements of the carbide compounds except carbon carbide, an organic solvent and a dispersant.

Another aspect of the present invention provides a method of preparing an emitter comprising: i) preparing a composition for the emitter by agitating a suspension including carbide-derived carbon which has been prepared by thermochemically-reacting carbide compounds with halogen-containing gases to extract all elements of the carbide compounds except carbon, an organic solvent and a dispersant; ii) dispersing the composition for the emitter on a substrate using an inkjet printer including a nozzle; and iii) calcinating the dispersed resulting product.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a partial cross-sectional view illustrating an electron emission device according to an embodiment of the present invention;

FIGS. 2A and 2B are a scanning electron microscope (SEM) image and a transmitting electron microscope (TEM) image, respectively, of carbide-derived carbon, according to various embodiments of the present invention;

FIG. 3 is a luminescent photograph of a manufactured electron emission device according to an embodiment of the present invention; and

FIG. 4 is a graph illustrating current density of an electron emission device as a function of electrical field, according to an embodiment of the present invention.

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

Aspects of the present invention provide an emitter in which manufacturing costs can be remarkably decreased, using an ink jet method, as well as a composition for the emitter which is more suitable than carbon nanotubes.

Aspects of the present invention also provide that the composition for the emitter includes carbide-derived carbon prepared using a method in which carbide compounds are thermochemically reacted with halogen-containing gases to remove all elements of the carbide compounds except carbon, as well as an organic solvent and a dispersant.

The carbide-derived carbon may be prepared using a method in which carbide compounds are thermochemically reacted with halogen-containing gases to extract all elements of the carbide compounds except carbon. This method is disclosed in Korean Patent Publication No. 2001-13225. That is, the carbide-derived carbon may be prepared using a method including: i) forming workpieces comprised of particles of carbide compounds having a predetermined transport porosity, and ii) thermochemically treating the workpieces with halogen-containing gases at a temperature in the range of 350 through 1200° C. to extract all elements of the workpieces except carbon. As a result, the carbide-derived carbon has a nano porosity throughout the workpieces.

Carbide-derived carbon and an ink jet method are more suitable than conventional carbon nanotubes for preparing the emitter according to an embodiment of the present invention using, since carbon nanotubes are fiber type having a high aspect ratio while carbide-derived carbon is flake type having an aspect ratio of about 1 so that carbide-derived carbon has a very small field enhancement factor, β. In addition, carbide-derived carbon can easily be used to regulate the size of a completed emitter by using a specifically designed application of the carbide.

The carbide compound for preparing carbide-derived carbon may be a compound including carbon and a Group II, Group III, Group IV, Group V, or Group Vi element. Such a carbide compound can be a diamond-based carbide, such as silicon carbide (Si—C) or boron carbide (B—C); a carbide, such as titanium carbide (Ti—C) or zirconium carbide (Zr—C); a salt-based carbide, such as aluminum carbide (Al—C) or calcium carbide (Ca—C); a complex carbide, such as titanium-tantalum carbide (Ti—Ta—C) or molybdeum-tungsten carbide (Mo—W—C); a carbonitride, such as titanium carbonitride (Ti—C—N) or zirconium carbonitride (Zr—C—N); or a blend thereof. Among these compounds described above, when silicon carbide, boron carbide, aluminum carbide, or a blend thereof is used, the carbide-induced carbon can be produced in high yield, and an electron emission device manufactured using the carbide-induced carbon has an excellent emission performance, and long lifetime. When the carbide-induced carbon is prepared using a silicon carbide represented by SiₓC_{y}, a mole ratio of y to x may be in the range from 0.95 to 1.05, which is desired in terms of stoichiometry and structural stability. When the carbide-induced carbon is prepared using a silicon carbide represented by B_{x′}C_{y′} a mole ratio of y′ to x′ may be in the range from 0.24 to 0.26, which is desired in terms of stoichiometry and structural stability. When the carbide-induced carbon is prepared using a silicon carbide represented by Al_{x″}C_{y″}, a mole ratio of y″ to x″ may be in the range from 0.74 to 0.76, which is desired in terms of stoichiometry and structural stability. The halogen-containing gas for preparing carbide derived carbon may be Cl₂, TiCl₄ or F₂.

The composition for preparing the emitter according to the current embodiment of the present invention includes a dispersant. The dispersant may be at least one compound selected from the group consisting of alkylamines, carboxylic acid esters, carboxylic acid amides, amino carboxylic acid salts and phosphorus based acid compounds, but is not limited thereto. At least one kind of the alkylamine, carboxylic acid esters, carboxylic acid amide, amino carboxylic acid salts or phosphorus based acid compounds is used as the dispersant, and they function as stable dispersants in the composition according to the current embodiment of the present invention.

The alkylamine may be a primary amine such as butylamine, octylamine, hexadodecylamine, cocoamine, tallowamine, hydrogenated tallowamine, oleylamine, laurylamine, stearylamine, or the like; a secondary amine such as dicocoamine, dihydrogenated tallowamine, distearylamine, or the like; a tertiary amine such as dodecyldimethylamine, didodecyl dimethylamine, tetradecyl dimethylamine, octadecyl dimethylamine, cocodimethylamine, dodecyltetradecyl dimethylamine, trioctylamine, or the like; or a diamine such as naphthalene diamine, stearyl propylene diamine, octamethylenediamine, nonanediamine, or the like.

The carboxylic acid amide and the amino carboxylic acid salts may be stearic acid amide, palmitic acid amide, lauric acid laurylamide, oleic acid amide, oleic acid diethanolamide, oleic acid laurylamide, stearanilide, oleylaminoethyl glycine, or the like. The carboxylic acid ester may be stearic acid ester, palmitic acid ester, lauric acid ester, oleic acid ester, or the like. The phosphorus based acid compound may be phosphoric acid, phosphorous acid, hypo-phosphorous acid, trimethyl phosphate, triethyl phosphate, tributyl phosphate, triphenyl phosphate, diethyl phosphite, diphenyl phosphite, and mono(2-methacryloyloxyethyl)acid phosphate.

According to an embodiment of the present invention, the amount of the dispersant may be 10 through 100 parts by weight based on 100 parts by weight of the carbide-derived carbon. When the amount of the dispersant is less than 10 parts by weight based on 100 parts by weight of the carbide-derived carbon, the carbide-derived carbon in the composition cannot be sufficiently dispersed. When the amount of the dispersant is more than 100 parts by weight based on 100 parts by weight of the carbide-derived carbon, the repulsive force between the particles is decreased due to cohesion of the dispersant itself. In other words, outside of the preferred range, the dispersion is not uniform.

The organic solvent included in the composition according to the current embodiment of the present invention may be a common organic solvent which is suitable for forming the emitter using an ink jet method. For example, the organic solvent may be: i) a chain alkane such as hexane, heptane, octane, decane, undecane, dodecane, tridecane, tetradecane, trimethylpentane, or the like; ii) a cyclic alkane such as cyclohexane, cycloheptane, cyclooctane, or the like; iii) an aromatic hydrocarbon such as benzene, toluene, xylene, trimethylbenzene, dodecylbenzene, or the like; or iv) an alcohol such as hexanol, heptanol, octanol, decanol, cyclohexanol, terpineol, citronellol, geraniol, phenylethanol, or the like. These organic solvents may be used alone or in the form of mixed solvents.

According to an embodiment of the present invention, the amount of the organic solvent may be 50 through 200 parts by weight based on 100 parts by weight of the carbide-derived carbon. When the amount of the organic solvent is less than 50 parts by weight based on 100 parts by weight of the carbide-derived carbon, it is difficult to eject the composition from the head of an ink jet printer because of the high viscosity of the organic solvent and thus a nozzle can be easily clogged. When the amount of the organic solvent is more than 200 parts by weight based on 100 parts by weight of the carbide-derived carbon, it is difficult to form a pattern having the desired thickness and the organic solvent tends to precipitate during storage and preservation of the mixture.

The composition according to the current embodiment of the present invention may further include an organic binder or additives beside the carbide-derived carbon, the dispersant and the organic solvent. Examples of the organic binder include thermoplastic resins such as ethyl cellulose, acrylate, acryl copolymer, melamine resins, urea derivatives, phenolic resins, rosin resins, etc. Examples of the additive include a defoamer, a plasticizer, an antifoamer, a flattening agent, a lubricant, a thickener, a cross-linking agent, a UV absorber, etc. The organic binder keeps halftone dots of ink in positions that do not have an absorbing layer, and prevents the ink from spreading by raising the surface tension.

In particular, high temperature calcination treatment is required in order to prevent the attachment of the ink jet solvent to the substrate. In this case, additives for the high temperature calcination treatment are silicon-based inorganic binders such as vinyltrimethoxysilane, vinyltrimethylsilane, glass frit, or the like.

According to the current embodiment of the present invention, the composition may be manufactured by preparing a highly dispersed suspension of carbide-derived carbon, dispersant and organic solvent using common mechanical agitation, ultrasonic treatment, grinding, sand milling, or the like, then mixing in the organic or inorganic binder and other additives and agitating the mixture again, or alternatively, using a method mixing all the above constituents simultaneously.

Meanwhile, an embodiment of the present invention provides a method of preparing an emitter using the composition. The method includes preparing the composition by agitating a suspension containing carbide-derived carbon, an organic solvent and a dispersant; dispersing the composition on a substrate using an inkjet printer including a nozzle; and calcinating the dispersed resulting product. In this case, the carbide-derived carbon will have been prepared by thermochemically reacting carbide compounds with halogen-containing gases to extract all elements of the carbide compounds except carbon.

Accordingly, the emitter according to the current embodiment of the present invention may be prepared using a conventional ink jet method except that the composition for preparing the emitter according to an embodiment of the present invention is used as ink for the ink jet printer.

The emitter is prepared using the ink jet method. Thus, the emitter may be prepared without an electrode substrate formed of transparent materials. Since an additional patterning procedure is not required, the preparation time can be shortened and materials used in the preparation may be saved. In addition, non-uniform emission due to residue generated in a conventional printing method can be avoided. In particular, the ink jet method can be easily applied using the flake type carbide-derived carbon. Further, a micro-electrode can be manufactured in which an arc discharge does not occur even in the presence of a strong electric field.

In addition, an emitter prepared using the inkjet method is provided, according to an embodiment of the present invention.

The emitter according to the current embodiment of the present invention is an emitter for cold cathodes. The emitter emits electrons by photoelectric emission, electric field emission, or the like, where the field is generated by secondary electron emission from ion bombardment and ion recombination rather than from heating. In addition, the emitter includes the carbide-derived carbon having good electron emission properties. Accordingly, the emitter according to the current embodiment of the present invention has good electron emission efficiency.

An electron emission device including the emitter according to an embodiment of the present invention may include a first substrate, a cathode electrode and the emitter which are formed on the first substrate, and a gate electrode formed to be electrically insulated from the cathode electrode by an insulating layer which is interposed between the gate electrode and the cathode electrode. Here, the emitter includes the carbide-derived carbon according to an embodiment of the present invention.

The emitter may further include a second insulating layer covering an upper part of the gate electrode, or alternatively the emitter may further include a focus electrode which is insulated from the gate electrode by the second insulating layer, and formed in parallel with the gate electrode. The second insulating layer and the emitter may be shaped in various forms.

The emitter can be used in vacuum electric devices such as flat panel displays, televisions, X line tubes, emission gate amplifiers, or the like.

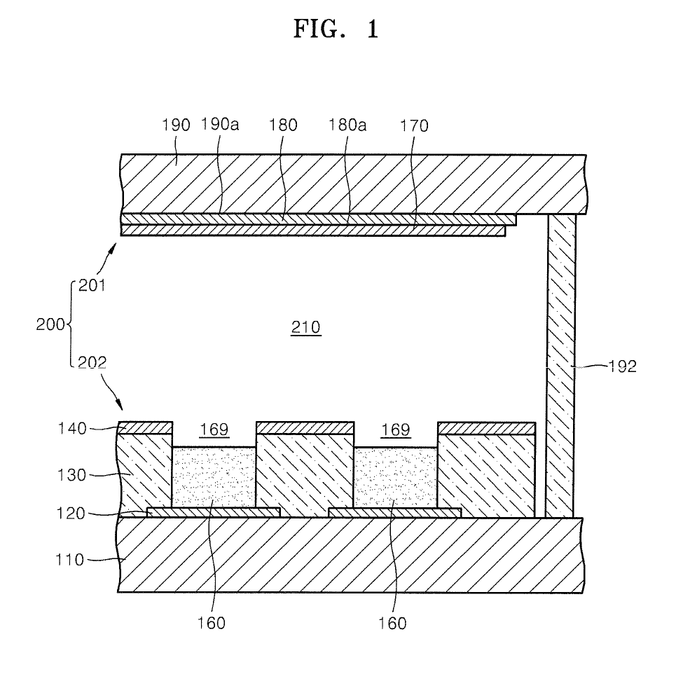

FIG. 1 is a partial cross-sectional view illustrating an electron emission device 200 according to an embodiment of the present invention. The electron emission device 200 illustrated in FIG. 1 is a triode electron emission device which is a representative electron emission device.

Referring to FIG. 1, the electron emission device 200 includes an upper plate 201 and a lower plate 202. The upper plate 201 includes an upper substrate 190, an anode electrode 180 formed on a lower surface 190a of the upper substrate 190, and a phosphor layer 170 formed on a lower surface 180a of the anode electrode 180.

The lower plate 202 includes a lower substrate 110 formed opposite and in parallel to the upper substrate 190 to have a predetermined interval as an inner space 210 between the lower substrate 110 and the upper substrate 190, an elongated form cathode electrode 120 formed on the lower substrate 110, an elongated form gate electrode 140 formed to cross the cathode electrode 120, an insulating layer 130 formed between the gate electrode 140 and the cathode electrode 120, emitter holes 169 defined by the insulating layer 130 and the gate electrode 140, and emitters 160 which are formed in the emitter holes 169 to have a height lower than that of the gate electrode 140, and supplying electric current to the cathode electrode 120.

The upper plate 201 and the lower plate 202 are maintained in a partial vacuum at a pressure lower than atmospheric pressure. A spacer 192 is formed between the upper plate 201 and the lower plate 202 so as to support the pressure that is caused by the partial vacuum, between the upper plate 201 and the lower plate 202 as well as to define the emission space 210.

A high voltage, required for accelerating electrons emitted from the emitters 160, is applied to the anode electrode 180, causing the electrons to collide with the phosphor layer 170 at high speed. The phosphor layer 170 is excited by the electrons and emits visible rays and then the electrons drop from a high energy level to a low energy level. For a color electron emission device, a plurality of the light emission spaces 210 that constitute each unit pixel of phosphor layer 170 incorporate a red light emission material, a green light emission material, and a blue light emission material disposed on the bottom surface 180 of the anode.

The gate electrode 140 causes electrons to be easily emitted from the emitters 160. The insulating layer 130 defines the emitter holes 169, and insulates the emitters 160 from the gate electrode 140.

As described above, the emitters 160 include carbide-derived carbon which emits electrons by forming an electric field.

The present invention will now be described in further detail with reference to the following examples. These examples are for illustrative purposes only, and are not intended to limit the scope of the present invention.

Preparation of Carbide-Derived Carbon

First, as a carbon precursor, 100 g of α-SiC particles having a mean diameter of 0.7 μm were prepared in a high temperature furnace composed of a graphite reaction chamber, a transformer, etc. 0.5 l of Cl₂ gas was applied to the high temperature furnace at 1000° C. for one minute. Then, 30 g of carbide-derived carbon were prepared by extracting Si from the carbon precursor using a thermochemical reaction.

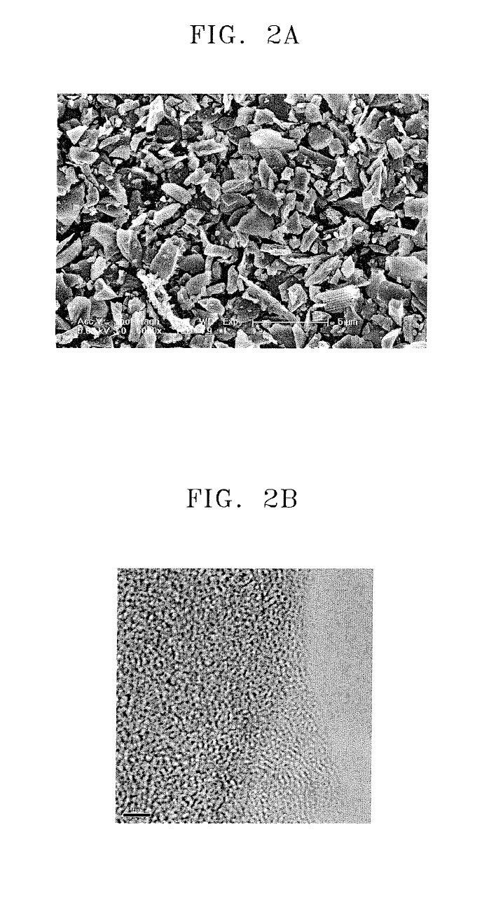

FIGS. 2A and 2B are a scanning electron microscope (SEM) image and a transmitting electron microscope (TEM) image of the carbide-derived carbon prepared using the above-described method.

Preparation of Composition for Forming Emitter

20.5 g of the carbide-derived carbon, 1.4 g of carboxyl acid ester as a dispersant, 35 g of tetradecane as an organic solvent, 11 g of acrylic resin as an organic binder, 1.5 g of vinyltrimethoxysilane as an inorganic binder, and 0.3 g of phosphoric acid as an additive were mixed and dispersed using a 3-roll mill to obtain a composition for preparing an emitter according to an embodiment of the present invention.

Preparation of Emitter

The composition in the form of an ink was ejected onto a borosilicate glass substrate to have a width of 20 μm, a coating thickness of 3 μm and a length of 5.08 cm by a piezo method using a conventional ink jet printer having a single. Then, the emitter according to an embodiment of the present invention was prepared by calcinating the resulting product using an electric furnace at 400° C. for 30 minutes.

Manufacture of Electron Emission Device

An electron emission device was manufactured using the emitter as a cold cathode, a polyethyleneterephthalate film having a thickness of 100 μm as a spacer and a copper anode plate.

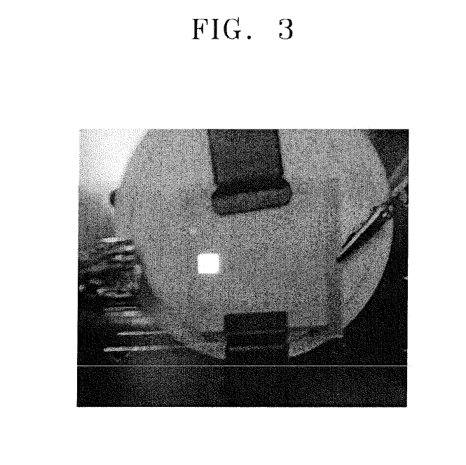

FIG. 3 is a luminescent photograph of the manufactured electron emission device according to an embodiment of the present invention.

Estimation Of Performance Of Electron Emission Device

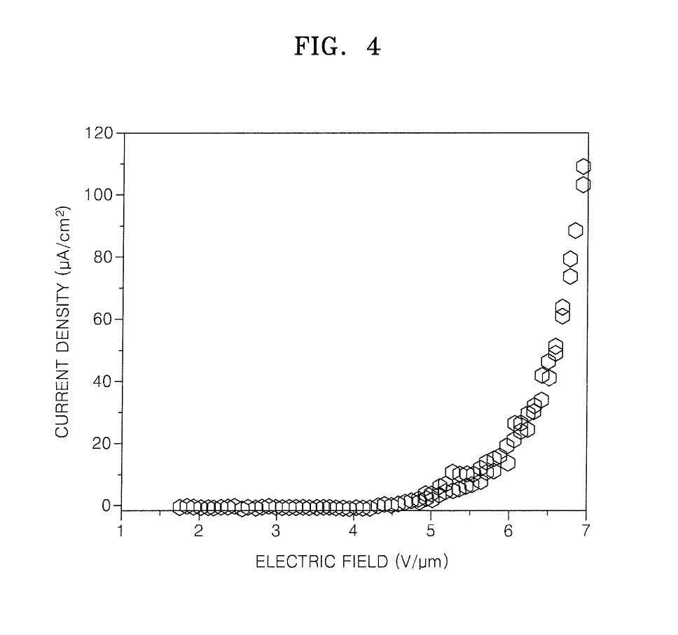

The emission current density of the manufactured electron emission device was measured by applying a pulse voltage at 1/500 duty ratio. The electron emission device had a turn-on field of about 4.6 V/μm and a good electron emission performance of about 6.9 V/μm and 100 μA/cm². FIG. 4 is a graph illustrating current density of the electron emission device as a function of electrical field, according to this embodiment of the present invention.

As described above, an emitter according to an aspect of the present invention has good uniformity and a long lifetime. An emitter can be prepared using a more inexpensive method than that using conventional carbon nanotubes. In addition, a pattern can be formed by easily regulating the size of the completed emitter using an ink jet method without using an additional patterning method. In particular, non-uniform emissions can be prevented that would be generated by the residue created using a conventional printing method. Further, flake type carbide-derived carbon manufactured by this method can easily be used in an ink jet method of printing. In addition, a micro electrode, in which an arc discharge does not occur even in the presence of a strong electric field, can be manufactured conveniently using the flake type carbide-derived carbon.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. A composition for preparing an emitter comprising: carbide-derived carbon which is prepared by thermochemically reacting carbide compounds with halogen-containing gases to extract all elements of the carbide compounds except carbon, an organic solvent and a dispersant.

2. The composition of claim 1, wherein the carbide compound consists of at least one compound selected from the group consisting of silicon carbide (Si—C), boron carbide (B—C), titanium carbide (Ti—C), zirconium carbide (Zr—C), aluminum carbide (Al—C), calcium carbide (Ca—C), titanium-tantalum carbide (Ti—Ta—C), molybdeum-tungsten carbide (Mo—W—C), titanium carbonitride (Ti—C—N) and zirconium carbonitride (Zr—C—N).

3. The composition of claim 1, wherein the dispersant is at least one compound selected from the group consisting of an alkylamine, carboxylic acid ester, carboxylic acid amide, amino carboxylic acid salt and phosphorus based acid compound.

4. The composition of claim 3, wherein:
the alkylamine is one or more compounds selected from the group consisting of primary amines, secondary amines, tertiary amines and diamines;
the primary amine is selected from the group consisting of butylamine, octylamine, hexadodecylamine, cocoamine, tallow amine, hydrogenated tallow amine, oleylamine, laurylamine and stearylamine;
the secondary amine is selected from the group consisting of dicocoamine, dehydrogenated tallowamine and distearylamine;
the tertiary amine is selected from the group consisting of dodecyl dimethylamine, didodecyl dimethylamine, tetradecyl dimethylamine, octadecyl dimethylamine, cocodimethylamine, dodecyltetradecyl dimethylamine and trioctylamine; and
the diamine is selected from the group consisting of naphthalene diamine, stearyl propylene diamine, octamethylenediamine and nonanediamine.

5. The composition of claim 3, wherein:
the carboxylic acid ester is selected from the group consisting of stearic acid ester, palmitic acid ester, lauric acid ester, oleic acid ester and a mixture thereof;
the carboxylic acid amide is selected from the group consisting of stearic acid amide, palmitic acid amide, lauric acid laurylamide, oleic acid amide, oleic acid diethanolamide, oleic acid laurylamide and a mixture thereof;
the amino carboxylic acid salts are selected from the group consisting of stearanilide, oleylaminoethyl glycine and a mixture thereof; and
the phosphorus based acid compound is selected from the group consisting of phosphoric acid, phosphorous acid, hypo-phosphorous acid, trimethyl phosphate, triethyl phosphate, tributyl phosphate, triphenyl phosphate, diethyl phosphite, diphenyl phosphite, and mono(2-methacryloyloxyethyl)acid phosphate.

6. The composition of claim 1, wherein the amount of the dispersant is 10 through 100 parts by weight based on 100 parts by weight of the carbide-derived carbon.

7. The composition of claim 1, wherein:
the organic solvent is selected from one or more of the group consisting of chain alkanes, cyclic alkanes, aromatic hydrocarbons and alcohols;
the chain alkane is selected from the group consisting of hexane, heptane, octane, decane, undecane, dodecane, tridecane, tetradecane and trimethylpentane;
the cyclic alkane is selected from the group consisting of cyclohexane, cycloheptane and cyclooctane;
the aromatic is selected selected from the group consisting of benzene, toluene, xylene, trimethylbenzene and dodecylbenzene; and
the alcohol is selected from the group consisting of hexanol, heptanol, octanol, decanol, cyclohexanol, terpineol, citronellol, geraniol and phenylethanol.

8. The composition of claim 1, wherein the amount of the organic solvent is 50 through 200 parts by weight based on 100 parts by weight of the carbide-derived carbon.

9. The composition of claim 1, further comprising:
an additive and a binder;
wherein the additive is selected from one or more of the group consisting of a defoamer, a plasticizer, an antifoamer, a flattening agent, a lubricating agent, a thickener, a cross-linking agent and a UV absorber;
wherein the binder is selected from one or more of the group consisting of an organic binder and an inorganic binder;
wherein the organic binder is selected from the group consisting of ethyl cellulose, acrylate, acryl copolymer, melamine resin, urea derivatives, phenolic resins and rosin resin;
wherein the inorganic binder is selected from the group consisting of a silicon-based inorganic binder and glass frit; and
wherein the silicon-based inorganic binder is selected from the group consisting of vinyltrimethoxysilane and vinyltrimethylsilane.

10. A method of preparing an emitter comprising:
preparing a composition by agitating a suspension comprising carbide-derived carbon which is prepared by thermochemically reacting carbide compounds with halogen-containing gases to remove all elements of the carbide compounds except carbon, an organic solvent and a dispersant;
dispersing the composition for preparing the emitter on a substrate using an inkjet printer and a nozzle; and
calcinating the dispersed resulting product.

11. An emitter prepared using the method of claim 10.

12. The method of claim 11, wherein the emitter is an emitter for cold cathodes.

13. The method of claim 11, wherein the carbide compound consists of at least one compound selected from the group consisting of silicon carbide (Si—C), boron carbide (B—C), titanium carbide (Ti—C), zirconium carbide (Zr—C), aluminum carbide (Al—C), calcium carbide (Ca—C), titanium-tantalum carbide (Ti—Ta—C), molybdeum-tungsten carbide (Mo—W—C), titanium carbonitride (Ti—C—N) and zirconium carbonitride (Zr—C—N).
